(19) United States
(12) Patent Application Publication
(10) Pub. No.: US 2021/0295690 A1
(43) Pub. Date: Sep. 23, 2021

(54) SOFTWARE REWRITING DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP); Shogo KOBAYASHI, Saitama (JP)

(73) Assignee: HONDA MOTOR CO., LTD., Tokyo (JP)

(21) Appl. No.: 17/205,731

(22) Filed: Mar. 18, 2021

(30) Foreign Application Priority Data
Mar. 19, 2020 (JP) 2020-050291

(51) Int. Cl. G08G 1/123; B60W 30/18; G06F 8/656

(52) U.S. Cl. CPC G08G 1/123; G06F 8/656; B60W 30/18

(57) ABSTRACT

A software rewriting device includes: a user information acquisition unit configured to acquire information regarding whether a user who uses a moving body is a temporary user; a usage period-of-time acquisition unit configured to acquire information regarding a usage period of time where the user uses the moving body; a scheduled stop period-of-time acquisition unit configured to acquire information regarding a scheduled stop period of time where the moving body is stopped at a predetermined position; and a processing unit configured to execute a rewriting process of rewriting a software. When the moving body is stopped at the predetermined position in the usage period of time based on the information regarding the usage period of time and the information regarding the scheduled stop period of time, the processing unit executes the rewriting process at the predetermined position based on permission of the temporary user.

### CROSS-REFERENCE TO RELATED APPLICATIONS

The present application claims the benefit of priority of Japanese Patent Application No. 2020-050291, filed on Mar. 19, 2020, the content of which is incorporated herein by reference.

### TECHNICAL FIELD

The present invention relates to a software rewriting device capable of rewriting software of a moving body.

### BACKGROUND ART

In recent years, vehicles have been digitized and in-vehicle devices are controlled by a control device called an electronic control unit (ECU). Such a control device controls an in-vehicle device by executing a control program stored in advance in the own device. Further, a technique capable of updating the control program of such a control device is also known.

For example, JP-A-2010-243339 discloses a technique of updating a program of a control device that controls an operation of a device mounted on a vehicle when the vehicle is positioned in a safe place.

When software of a moving body is rewritten, there may be a case where some or all of the functions of the moving body cannot be used by a user. If the user who uses the moving body is a temporary user who can temporarily use the moving body, when a period of time where a function of the moving body cannot be used is present within a limited period of time, the degree of satisfaction for the moving body may largely deteriorate. From this point of view, there is room for improvement.

### SUMMARY

The invention provides a software rewriting device capable of rewriting software of a moving body while avoiding deterioration in the degree of satisfaction of a user for the moving body.

According to an aspect of the invention, there is provided a software rewriting device, configured to rewrite software of a moving body, including: a user information acquisition unit configured to acquire information regarding whether a user who uses the moving body is a temporary user who is capable of temporarily using the moving body; a usage period-of-time acquisition unit configured to acquire information regarding a usage period of time where the user uses the moving body; a scheduled stop period-of-time acquisition unit configured to acquire information regarding a scheduled stop period of time where the moving body is stopped at a predetermined position; and a processing unit configured to execute a rewriting process of rewriting the software, where when the moving body is stopped at the predetermined position in the usage period of time based on the information regarding the usage period of time and the information regarding the scheduled stop period of time, the processing unit executes the rewriting process at the predetermined position based on permission of the temporary user.

According to the aspect of the invention, software of a moving body can be rewritten while avoiding deterioration in the degree of satisfaction of a user for the moving body.

### BRIEF DESCRIPTION OF THE DRAWINGS

FIG. 1 is a diagram illustrating an example of a configuration of a vehicle system according to an embodiment;

FIG. 2 is a diagram illustrating an example of a vehicle reservation information table;

FIG. 3 is a diagram illustrating an example of a parking lot managed by a parking lot management device;

FIG. 4 is a diagram illustrating an example of a parking space information table;

FIG. 5 is a diagram illustrating an example of a parking reservation information table;

FIG. 6 is a diagram illustrating an example of a functional configuration of a software rewriting device;

FIG. 7 is a diagram illustrating an example of a user information table;

FIG. 8 is a flow chart illustrating an example of a rewriting execution process performed by the software rewriting device; and

FIG. 9 is a flow chart illustrating an example of a guide process performed by the software rewriting device.

### DESCRIPTION OF EMBODIMENTS

Hereinafter, an embodiment of the software rewriting device of the invention will be described with reference to the accompanying drawings. In the following description of the embodiment, an example will be described in which a moving body in the invention is a vehicle such as an automobile and an accommodation area in the invention is a parking lot.

First, a vehicle provided with a software rewriting device of the embodiment will be described. A vehicle (hereinafter, also referred to as vehicle M) provided with the software rewriting device of the embodiment is an automobile including a drive source (for example, a traveling driving force output device 200 described later) and wheels (for example, two wheels, three wheels, or four wheels) including driving wheels driven by the power of the drive source. As the drive source of the vehicle M, for example, an electric motor, an internal combustion engine (for example, a gasoline engine), or a combination of the electric motor and the internal combustion engine is used.

The vehicle M is managed by, for example, a predetermined vehicle management company and is temporarily rented by a person who desires to use the vehicle M in a state where the person is registered in the vehicle management company as a user who can use the vehicle M. For example, each user who can use the vehicle M can temporarily use the vehicle M by making a usage reservation for using the vehicle M in a vehicle management server 450 described below managed by the vehicle management company. In addition, the user who uses the vehicle M pays a usage fee for using the vehicle M to the vehicle management company. The embodiment is not limited to such example, the vehicle M may be managed and owned by an individual and may be temporarily rented by another individual.

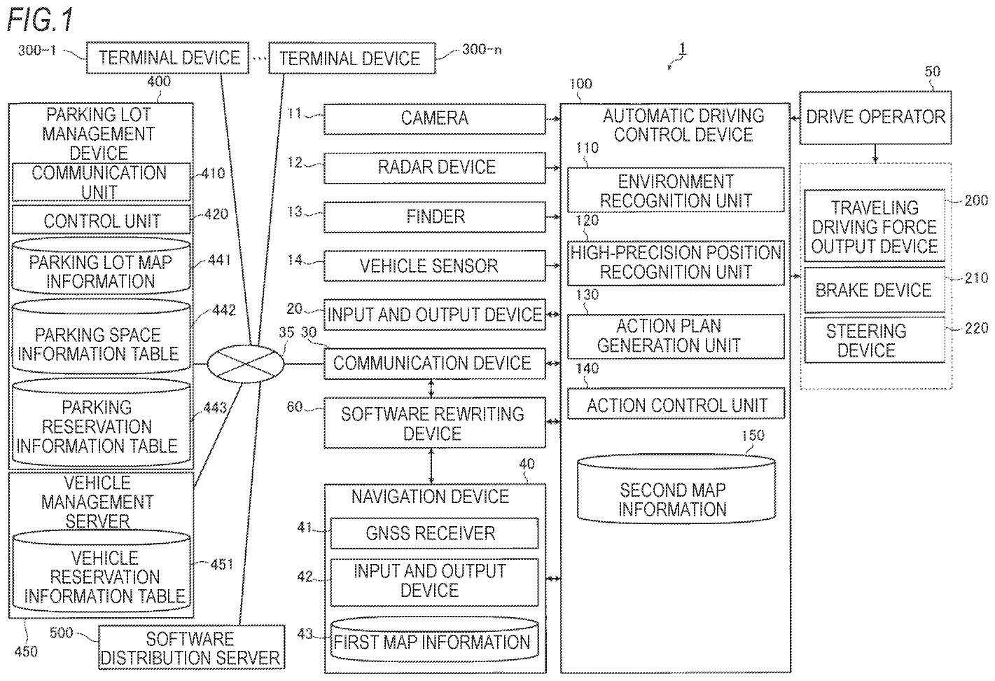

Further, the vehicle M includes a vehicle system 1 illustrated in FIG. 1. The vehicle system 1 has a function capable of performing all driving tasks related to the vehicle M, at least within a limited specific area (for example, in a parking lot PA described below). Here, the driving task is, for example, a real-time driving function necessary for maneuvering the vehicle M such as controlling a left-right movement (steering) of the vehicle M, controlling of a forward-backward movement (acceleration, deceleration), and monitoring the driving environment, and a tactical function such as planning a traveling track.

As illustrated in FIG. 1, the vehicle system 1 includes a camera 11, a radar device 12, a finder 13, a vehicle sensor 14, an input and output device 20, a communication device 30, a navigation device 40, a drive operator 50, a software rewriting device 60, an automatic driving control device 100, the traveling driving force output device 200, a brake device 210, and a steering device 220. The respective devices are communicably connected to each other by a wired or wireless communication network. The communication network connecting the respective devices is, for example, controller area network (CAN).

The camera 11 is a digital camera which photographs the periphery (for example, in front of the vehicle M)of the vehicle M and outputs image data obtained by the photographing to the automatic driving control device 100. The radar device 12 is, for example, a radar device using radio waves in a millimeter wave band, detects a position of an object in the vicinity (for example, in front of, behind, and to the side of the vehicle M) of the vehicle M, and outputs the detection result to the automatic driving control device 100.

The finder 13 is, for example, laser imaging detection and ranging (LIDAR). The finder 13 uses a predetermined laser beam to measure the distance to an object (target object) around (for example, in front of, behind, and to the side of the vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication environment) used by the communication device 30 for communication. The vehicle sensor 14 outputs the detection result of each sensor to the automatic driving control device 100. The automatic driving control device 100 may output the detection result of each sensor of the vehicle sensor 14 to the software rewriting device 60 or the like.

The input and output device 20 includes an output device which outputs various information to a user who is currently using the vehicle M (hereinafter, also simply referred to as a current user) and an input device which accepts various input operations from the current user. The output device of the input and output device 20 is, for example, a display which displays information based on a processing result of the automatic driving control device 100. The output device may be a speaker, a buzzer, an indicator light, or the like. Further, the input device of the input and output device 20 is, for example, a touch panel or an operation button (key, switch, or the like) which outputs an operation signal corresponding to an input operation received from the current user to the automatic driving control device 100.

The current user is, for example, a user who made a usage reservation for using the vehicle M in the vehicle management server 450 among users who can use the vehicle M, but is not limited thereto. For example, the current user may be a person who temporarily takes charge of the vehicle M on behalf of the user who made a usage reservation for using the vehicle M in the vehicle management server 450 or may be a person who made a usage reservation for using the vehicle M on behalf of a user who desires to make a usage reservation for using the vehicle M in the vehicle management server 450.

The communication device 30 is wirelessly connected to a network 35 and communicates with another device provided outside the vehicle system 1 via the network 35. The network 35 includes, for example, a mobile communication network, a Wi-Fi network, Bluetooth (registered trademark), dedicated short range communication (DSRC), and the like.

The communication device 30 communicates with, for example, terminal devices 300-1 to 300-n carried by respective users who can use the vehicle M. Each of the terminal devices 300-1 to 300-n is, for example, a smartphone or a tablet terminal, is connected to the network 35, and includes a display that displays various information, a touch panel that receives an input operation, or the like. Hereinafter, any terminal device among the terminal devices 300-1 to 300-n may be represented by “terminal device 300-i”.

In addition, the communication device 30 also communicates with, for example, a parking lot management device 400 that manages the parking lot PA where the vehicle M can be parked, the vehicle management server 450 that manages the vehicle M, and a software distribution server 500 that distributes software of the vehicle M. Further, the software distribution server 500 is, for example, a server (computer) managed by a manufacturer (for example, a maker) of the vehicle M, and distributes the software of the vehicle M registered in the software distribution server 500 by the manufacturer of the vehicle M. The vehicle management server 450, the parking lot PA, and the parking lot management device 400 will be described below.

The navigation device 40 includes a global navigation satellite system (GNSS) receiver 41 and an input and output device 42. Further, the navigation device 40 includes a storage device (not illustrated) such as a hard disk drive (hereinafter, also referred to as HDD) and a flash memory and first map information 43 is stored in the storage device. The first map information 43 is, for example, information representing a road shape by a link indicating a road and a node connected by the link. Further, the first map information 43 may include information representing the curvature of the road and a point of interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an inertial navigation system (INS) using the output of the vehicle sensor 14.

The input and output device 42 includes an output device which outputs various kinds of information to the current user and an input device which accepts various input operations from the current user. The output device of the input and output device 42 is, for example, a display which displays information (for example, displays a route on a map described below) based on the processing result of the navigation device 40. The input device of the input and output device 42 is, for example, a touch panel or an operation button (key, switch, or the like) which outputs an operation signal corresponding to the input operation received from the current user to the navigation device 40. The input and output device 42 may be shared with the input and output device 20.

Although detailed description is omitted, the navigation device 40 determines, for example, a route (hereafter, also referred to as the route on the map) from the position of the vehicle M specified by the GNSS receiver 41 to a destination input by the current user with reference to the first map information 43. Then, the navigation device 40 guides the current user on the determined route on the map by the input and output device 42. Further, the navigation device 40 is configured to be able to output information indicating the specified position of the vehicle M and the determined route on the map to the software rewriting device 60, the automatic driving control device 100, or the like.

Some or all the functions of the navigation device 40 may be realized by the terminal device 300-i. Further, some or all the functions of the navigation device 40 may be realized by an external server (navigation server) capable of communicating with the vehicle system 1 by the communication device 30 or the like.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor electronic control unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction (that is, the steering angle) of the steering wheels.

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like to which each functional unit (for example, the high-precision position recognition unit 120) of the automatic driving control device 100 can access and second map information 150 is stored in the storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the path in the parking lot PA, the position of each parking space, and the like from the parking lot management device 400. Then, the automatic driving control device 100 updates the second map information 150 to incorporate the received in-parking-lot map information into the second map information 150. As a result, the automatic driving control device 100 can specify the position of each parking space PS in the parking lot PA with reference to the second map information 150.

The environment recognition unit 110 performs sensor fusion processing on information acquired by a part or all of the camera 11, the radar device 12, and the finder 13, such that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA. Information regarding the position of the vehicle M recognized by the high-precision position recognition unit 120 may be used for various processes by the automatic driving control device 100 and may be output to the software rewriting device 60.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are disposed for each predetermined mileage (for example, about several meters). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the central processing unit (CPU) executing a predetermined program (software). A part or all of the functional parts of the automatic driving control device 100 may be realized by hardware such as large scale integration (LSI), application specific integrated circuit (ASIC), field-programmable gate array (FPGA), graphics processing unit (GPU), and for example, the storage device for storing the second map information 150 and the high-precision position recognition unit 120 may be realized by a map positioning unit (MPU). Further, a part or all of the functional parts included in the automatic driving control device 100 may be realized by the cooperation of software and hardware.

The software rewriting device 60 is configured to be able to communicate with other devices external to the vehicle system 1 via the communication device 30 and is configured to be able to communicate with other devices in the vehicle system 1 such as the navigation device 40 and the automatic driving control device 100. Then, the software rewriting device 60 communicates with the other devices and performs a rewriting process for rewriting the software of the vehicle M.

Here, the software of the vehicle M is, for example, a program for operating an in-vehicle device such as the navigation device 40 or the automatic driving control device 100, so-called firmware. Further, the software of the vehicle M may be data and may be, for example, the first map information 43, the second map information 150, or differential data for updating the data. Further, the software of the vehicle M may be the firmware of the software rewriting device 60 itself.

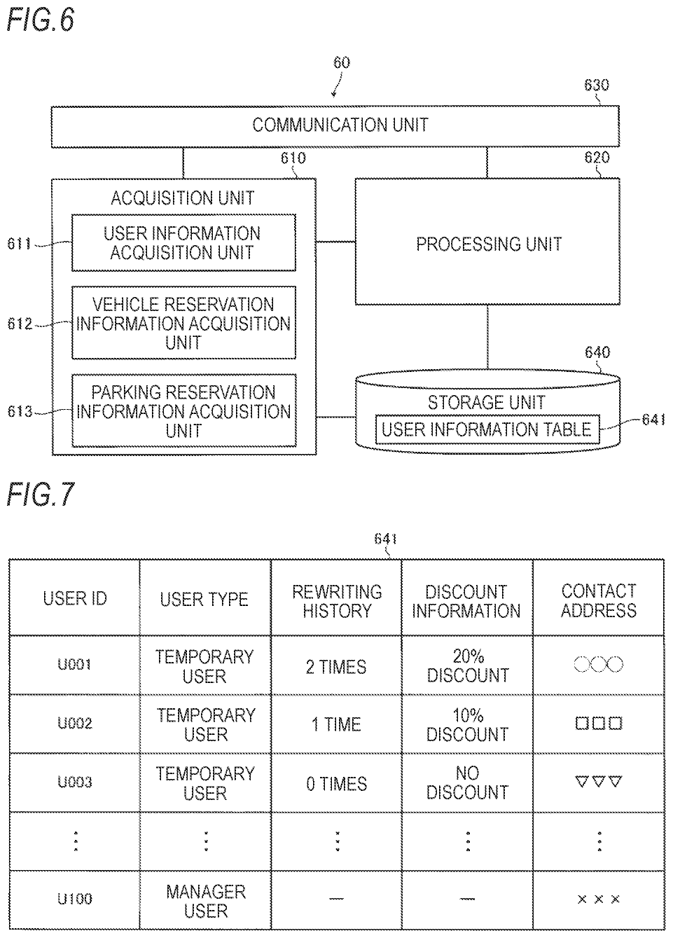

The software rewriting device 60 downloads (that is, receives) the software of the vehicle M from, for example, the software distribution server 500 and performs a rewriting process of rewriting the software to the downloaded software. For example, when new firmware for the automatic driving control device 100 is downloaded from the software distribution server 500, the software rewriting device 60 performs a rewriting process of rewriting the firmware of the automatic driving control device 100 with the new downloaded firmware. By performing such a rewriting process by the software rewriting device 60, it is possible to stabilize the operation of the device in which the software has been rewritten, improve the performance, add functions, and the like. An example of the configuration of the software rewriting device 60 will be described below with reference to FIG. 6 and the like.

Next, the vehicle management server 450 will be described. The vehicle management server 450 is a server (computer) that is operated by the vehicle management company managing the vehicle M. As described above, the vehicle management server 450 receives a usage reservation for using the vehicle M from each user who can use the vehicle M (person who is registered in the vehicle management company as a user), and can allow the user who made the usage reservation to temporarily use the vehicle M. For example, the vehicle management server 450 includes a storage unit (not illustrated) that is realized by a HDD or a flash memory, and the storage unit stores a vehicle reservation information table 451 and the like. In addition, the vehicle management server 450 is configured to output the content stored in the storage unit (for example, the vehicle reservation information table 451) to an external device (for example, the software rewriting device 60 of the vehicle M) via the network 35 or the like.

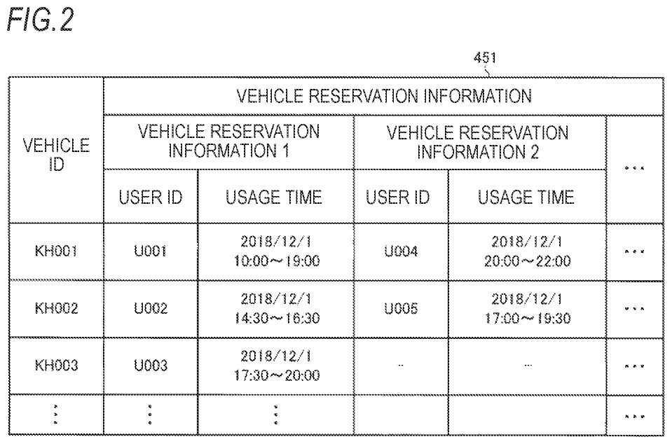

As illustrated in FIG. 2, the vehicle reservation information table 451 stores a vehicle ID and vehicle reservation information in association with each other. In addition, the vehicle reservation information table 451 may store a plurality of vehicle reservation information in association with respective vehicle IDs. The vehicle ID is an identifier (identification information) for identifying each vehicle and is, for example, a vehicle number or a frame number. The vehicle reservation information includes: a user ID that is an identifier (identification information) for identifying each user; and information regarding a scheduled usage period of time where the vehicle is used by the user.

For example, in the example illustrated in FIG. 2, as one piece of the vehicle reservation information (vehicle reservation information 1) corresponding to a vehicle ID “KH001”, information regarding a user ID “U001” and a usage period of time “Dec. 1, 2018 10:00 to 19:00” is stored in the vehicle reservation information table 451. This information represents that a vehicle (for example, the vehicle M) of the vehicle ID “KH001” is scheduled (usage reservation) to be used by a user of the user ID “U001” in a period of time “Dec. 1, 2018 10:00 to 19:00”.

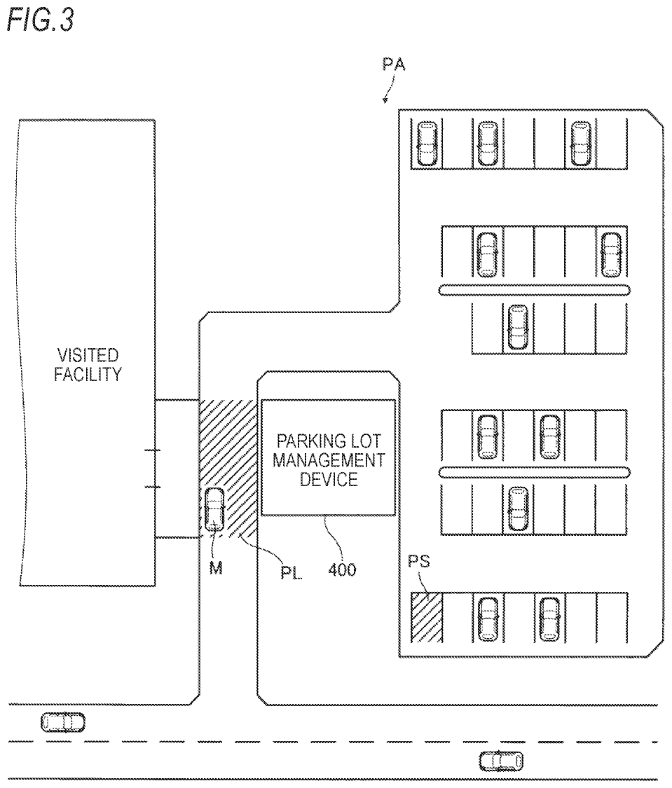

Next, the parking lot PA where the vehicle M can be parked and the parking lot management device 400 that manages the parking lot PA will be described. As illustrated in FIG. 3, the parking lot PA is an automatic valet parking type parking lot attached to a visited facility to be visited by a user. The parking lot PA includes a plurality of parking spaces PS where a vehicle (for example, vehicle M) can be parked and a platform PL provided right before the plurality of parking spaces PS.

The parking lot management device 400 is a device (computer) that manages the parking lot PA. For example, the parking lot management device 400 determines a parking position of a vehicle that enters the parking lot PA and instructs the vehicle to move to the determined parking position.

More specifically, as illustrated in FIG. 1, the parking lot management device 400 includes a communication unit 410 and a control unit 420. The communication unit 410 and the control unit 420 of the parking lot management device 400 are realized, for example, by a CPU executing a predetermined program (software) stored in advance. In addition, a part or all of the functional parts may be realized by hardware such as LSI, ASIC, FPGA, or GPU, or may be realized by the cooperation of software and hardware.

In addition, the parking lot management device 400 includes a storage unit (not illustrated) that is realized by a HDD or a flash memory, and the storage unit stores parking lot map information 441, parking space information table 442, parking reservation information table 443, and the like. In addition, the parking lot management device 400 is configured to output the content stored in the storage unit (for example, the parking reservation information table 443) to an external device (for example, the software rewriting device 60 of the vehicle M) via the network 35 or the like.

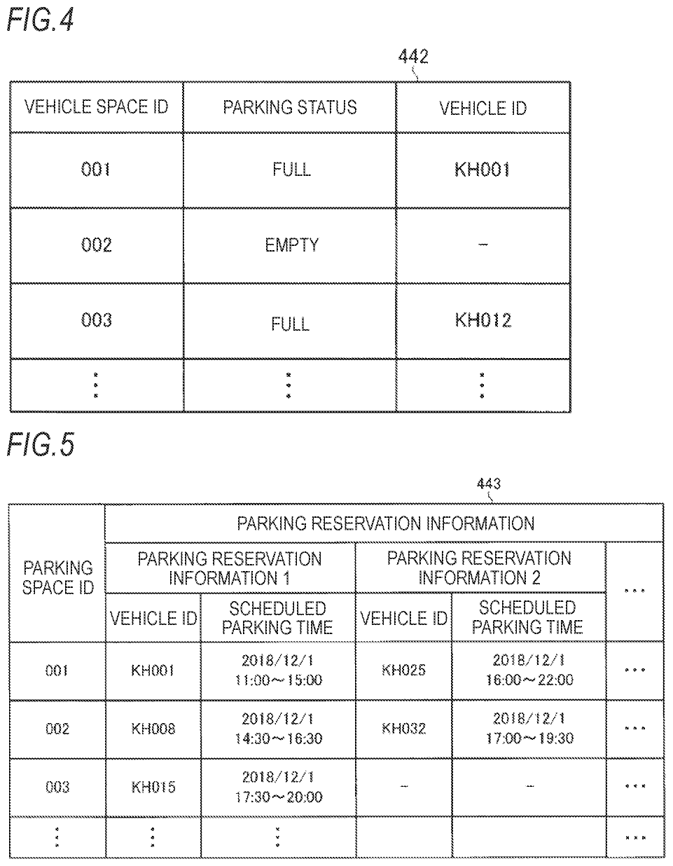

The parking lot map information 441 is information which geometrically represents the structure of the parking lot PA and includes, for example, information indicating the coordinates (positions) of the respective parking spaces PS. As illustrated in FIG. 4, the parking space information table 442 stores information in which a parking space ID, a parking status, and a vehicle ID are associated with each other. Here, the parking space ID is an identifier (identification information) for identifying each parking space PS. The parking status represents whether a vehicle is parked in the corresponding parking space PS. For example, when a vehicle is parked in the parking space PS, the parking status is “full”, and when a vehicle is not parked in the parking space PS, the parking status is “empty”. The vehicle ID is the identifier for each vehicle as described above. In the parking space information table 442, the vehicle ID is stored in association with the parking space PS of which the parking status is “full”, and represents the vehicle that is parked in the parking space PS.

In addition, the parking space information table 442 may further store information regarding a date and time where a vehicle is parked in each parking space PS (that is, an entry date and time where the vehicle enters each parking space PS), information regarding a scheduled exit date and time where a vehicle exits (leaves) from each parking space PS, and the like.

As illustrated in FIG. 5, the parking reservation information table 443 stores, for example, the parking space ID and parking reservation information in association with each other. In addition, the parking reservation information table 443 may store a plurality of parking reservation information in association with the respective parking space IDs. The parking space ID is an identifier for identifying each parking space PS as described above. The parking reservation information includes information regarding a vehicle ID for identifying each vehicle and a scheduled parking period of time where the vehicle is scheduled to be parked.

For example, in the example illustrated in FIG. 5, as one piece of the parking reservation information (parking reservation information 1) corresponding to a parking space ID “001”, information regarding a vehicle ID “KH001” and a scheduled parking period of time “Dec. 1, 2018 11:00 to 15:00” is stored in the parking reservation information table 443. The information represents that the vehicle of the vehicle ID “KH001” is scheduled to be parked in the parking space PS of the parking space ID “001” in the period of time “Dec. 1, 2018 11:00 to 15:00”.

Here, an example in which the user of the vehicle M uses the parking lot PA, that is, the vehicle M is parked in the parking lot PA will be described. Prior to using the parking lot PA, the user makes a parking reservation of the parking lot PA using the navigation device 40, the terminal device 300-1, or the like. The “user” is not limited to the owner and manager of the vehicle M, but includes, for example, a person (for example, a concierge) who performs procedures such as parking reservation on behalf of the owner of the vehicle M. In the parking reservation, the user inputs the vehicle ID of the vehicle M, the scheduled parking period of time where the vehicle M is parked in the parking lot PA, and the like. The input information is sent to the parking lot management device 400. The parking lot management device 400 determines whether the parking space PS where the vehicle M can be parked is present in the scheduled parking period of time with reference to the received information regarding the vehicle ID or the scheduled parking period of time and the parking reservation information table 443. When the parking space PS where the vehicle M can be parked is present, the parking lot management device 400 stores the received information regarding the vehicle ID or the scheduled parking period of time in the parking reservation information table 443 in association with the parking space PS, and notifies reception of the parking reservation to the user.

Next, when the scheduled parking period of time comes, the user rides the vehicle M on the platform PL and gets off from the vehicle M at the platform PL. After the user gets off the vehicle M, the vehicle M automatically drives and executes a self-propelled entry event to move to a predetermined parking space PS in the parking lot PA. For example, when the user gets off the vehicle M at the platform PL, the user sends a request for starting the self-propelled entry event to the parking lot management device 400 by the terminal device 300-i or the like. When the parking lot management device 400 receives the start request of the self-propelled entry event, the parking lot management device 400 specifies the parking space PS to which the vehicle M should enter with reference to the parking reservation information table 443 and instructs the vehicle M to move to the parking space PS. Further, the parking lot management device 400 may also determine a route along which the vehicle M should travel to the parking space PS where the vehicle M should enter, and instruct the vehicle M to move along the route. The vehicle M that receives the instruction from the parking lot management device 400 moves to the parking space PS designated by the parking lot management device 400 while performing sensing with the camera 11, the radar device 12, the finder 13, or the like.

When exiting from the parking lot PA, the user causes the vehicle M to execute a self-propelled exit event. When the vehicle M executes a self-propelled exit event, the vehicle M automatically drives from the parked parking space PS and moves to the platform PL. For example, when the vehicle M is made to execute the self-propelled exit event, the user sends a start request of the self-propelled exit event to the parking lot management device 400 by their terminal device 300-i or the like. Upon receiving the start request of the self-propelled exit event, the parking lot management device 400 instructs the vehicle M to move to the platform PL. Here, the parking lot management device 400 may also determine the route on which the vehicle M should travel to the platform PL and instruct the vehicle M to move along the route. The vehicle M which has received the instruction from the parking lot management device 400 moves to the platform PL while sensing with the camera 11, the radar device 12, the finder 13, or the like. Then, the user gets on the vehicle M at the platform PL and exits from the parking lot PA.

Next, an example of the functional configuration of the software rewriting device 60 will be described with reference to FIG. 6. As illustrated in FIG. 6, the software rewriting device 60 includes an acquisition unit 610 which acquires various information, a storage unit 640 which stores various information, and a processing unit 620 which performs various processing based on the information acquired by the acquisition unit 610 or the information stored in the storage unit 640. Further, the software rewriting device 60 includes a communication unit 630 which functions as an interface for the software rewriting device 60 to communicate with another device. The acquisition unit 610 and the processing unit 620 are configured to be able to communicate with other devices as appropriate via the communication unit 630.

The acquisition unit 610, the processing unit 620, and the communication unit 630 are realized, for example, by a CPU executing a predetermined program (software) stored in advance. In addition, a part or all of the functional parts may be realized by hardware such as LSI, ASIC, FPGA, or GPU, or may be realized by the cooperation of software and hardware.

The storage unit 640 is realized by a HDD or a flash memory and stores, for example, a user information table 641. The user information table 641 stores user information regarding each user who can use the vehicle M. As illustrated in FIG. 7, the user information table 641 stores, for example, information in which a user ID, a user type, a rewriting history, discount information, and a contact address are associated with each other as the user information.

Here, the user ID is an identifier for each user as described above. The user type represents an attribute of each user and specifically represents whether the user is a temporary user who can temporarily use the vehicle M. In addition, the user type may further represent whether the user is a user (illustrated as “manager user” in FIG. 7) who can use the vehicle M without any time restriction.

The rewriting history represents the number of times each user previously permits to execute the rewriting process. That is, a user of which the rewriting history is 1 time or more is a user (hereinafter, also referred to as “permitted user”) who previously permits to execute the rewriting process, and a user of which the rewriting history is 0 times is a user (hereinafter, also referred to as “non-permitted user”) who did not previously permit to execute the rewriting process.

The discount information represents, for example, a discount rate of a usage fee of the vehicle M (hereinafter, also referred to as “vehicle usage fee”) applied to each user. In addition, the discount information may represent a discount rate of a parking fee (hereinafter, also simply referred to as “parking fee”) for which each user parks a vehicle in a pay-by-the-hour parking lot (for example, the parking lot PA). As the discount information, for example, “no discount” representing the discount rate is 0%, “10% discount” representing the discount rate is 10%, or “20% discount” representing the discount rate is 20% are stored. In addition, the contact address represents a contact address of each user, for example, a telephone number or a mail address of each of the terminal device 300-1 to 300-n.

The acquisition unit 610 includes a user information acquisition unit 611, a vehicle reservation information acquisition unit 612, and a parking reservation information acquisition unit 613. The user information acquisition unit 611 acquires user information regarding the current user who is currently using the vehicle M. For example, the vehicle M communicates with the terminal device 300-i of the current user at a predetermined timing such as the time when a door is unlocked, and acquires information regarding the user ID of the current user. The user information acquisition unit 611 acquires the user information corresponding to the user ID of the current user acquired as described above from the user information table 641. As a result, the current user can acquire information regarding whether the current user is the temporary user.

The vehicle reservation information acquisition unit 612 acquires the vehicle reservation information regarding the vehicle M. The vehicle reservation information acquisition unit 612 acquires the vehicle reservation information corresponding to the vehicle ID of the own vehicle and the user ID of the current user from the vehicle management server 450, for example, via the communication unit 630. As a result, information regarding the usage period of time where the current user uses the vehicle M can be acquired. The vehicle reservation information acquisition unit 612 may acquire the vehicle reservation information regarding the vehicle M only when the information representing that the current user is the temporary user is acquired by the user information acquisition unit 611.

The parking reservation information acquisition unit 613 acquires the parking reservation information regarding the vehicle M. The parking reservation information acquisition unit 613 acquires the parking reservation information including the vehicle ID of the own vehicle from the parking lot management device 400, for example, via the communication unit 630. As a result, information regarding the scheduled parking period of time where the vehicle M is parked in the parking lot PA can be acquired. The parking reservation information acquisition unit 613 may acquire the parking reservation information regarding the vehicle M only when the information representing that the current user is the temporary user is acquired by the user information acquisition unit 611.

In addition, when the parking reservation information including the vehicle ID of the vehicle M is not present, the parking lot management device 400 may notify, for example, the software rewriting device 60 that the parking reservation information including the vehicle ID of the vehicle M is not present. Here, the parking reservation information acquisition unit 613 acquires information representing that the vehicle M is not scheduled to be parked in the parking lot PA.

The processing unit 620 executes the rewriting process of rewriting the software of the vehicle M. For example, when the vehicle M is parked in the parking lot PA in the usage period of time where the current user uses the vehicle M based on the vehicle reservation information acquired by the vehicle reservation information acquisition unit 612 and the parking reservation information acquired by the parking reservation information acquisition unit 613, the processing unit 620 executes the rewriting process in the parking lot PA based on the permission of the current user.

For example, the processing unit 620 causes a display of the navigation device 40 or the like to display a message “There is an update for the software. Do you want to rewrite the software in OO parking lot?” or operation buttons “YES” and “NO” to check with the current user whether to execute the rewriting process. When the permission of the execution of the rewriting process is received from the current user, for example, by pressing the operation button “YES”, the processing unit 620 executes the rewriting process on the condition that the vehicle M is parked in the parking lot PA, that is, the vehicle M is stopped at a position in the parking lot PA.

That is, when rewriting the software of the vehicle M, the current user may not be able to use a part (for example, the device for which the software is rewritten) or all of the vehicle system 1, which may reduce the convenience of the current user. In particular, if the current user is the temporary user who can temporarily use the vehicle M, when a period of time where a part or all of the functions of the vehicle system 1 cannot be used is present within a limited period of time, the user is very unsatisfactory for the vehicle M, which may lead to deterioration in the operation of the vehicle M.

As described above, when the vehicle M is parked in the parking lot PA in the usage period of time of the current user, the software rewriting device 60 executes the rewriting process in the parking lot PA based on the permission of the current user. As a result, the rewriting process can be prevented from being executed against the will of the current user, and the rewriting process can be executed while avoiding deterioration in the convenience of the current user. Accordingly, the software of the vehicle M can be rewritten while avoiding deterioration in the degree of satisfaction of the current user for the vehicle M.

In addition, for example, when the rewriting process is executed based on the permission of the current user, the processing unit 620 updates the user information corresponding to the current user. Specifically, the processing unit 620 adds “1” to the rewriting history corresponding to the current user, and stores information representing a predetermined discount rate as the discount information corresponding to the current user.

For example, the processing unit 620 stores the discount information “10% discount” when the rewriting history is “1 time”, stores the discount information “20% discount” when the rewriting history is “2 times”, and stores the discount information “30% discount” when the rewriting history is “3 times”.

When the current user pays the vehicle usage fee or the parking fee, the processing unit 620 executes a process of discounting the fee based on the discount information of the current user. For example, when the discount information of the current user represents “20% discount”, the processing unit 620 executes a process of discounting the vehicle usage fee or the parking fee of the current user by 20%. As a result, an incentive corresponding to the number of times the execution of the rewriting process is permitted can be provided, and the execution of the rewriting process is promoted.

In addition, as described above, in a case where the processing unit 620 stores the discount information “10% discount” when the rewriting history is “1 time” and stores the discount information “20% discount” when the rewriting history is “2 times”, when the permitted user who previously permits to execute the rewriting process permits to execute the rewriting process again, the processing unit 620 may discount the vehicle usage fee or the parking fee to be cheaper than that when the permitted user previously permits to execute the rewriting process. As a result, as the number of times the execution of the rewriting process is permitted increases, a higher incentive can be provided, and the execution of the rewriting process is promoted.

In addition, when the software of the vehicle M is rewritable, the processing unit 620 may determine a user to which a state where the software of the vehicle M is rewritable is guided based on the user information of each user who can use the vehicle M, and may guide the state where the software of the vehicle M is rewritable to the determined user.

For example, the processing unit 620 guides the state where the software is rewritable to the permitted user (that is, the user of which the rewriting history is “one time” or more) in preference to the non-permitted user (that is, the user of which the rewriting history is “0 time”) among the users who can use the vehicle M. Specifically, here, the processing unit 620 guides the state where the software is rewritable, for example, only to the permitted user first. If the software is not rewritten even after a predetermined period of time is elapsed from the guide, the processing unit 620 guides the state where the software is rewritable to all the users who can use the vehicle M including the non-permitted user. In addition, the processing unit 620 may guide the state where the software is rewritable to the users in order from the user of which the rewriting history is the largest. By preferentially guiding the state where the software is rewritable to the permitted user, an intelligent rewriting process of which execution can be easily permitted can be requested.

On the other hand, the processing unit 620 may guide the state where the software is rewritable to the non-permitted user in preference to the permitted user. Specifically, here, the processing unit 620 guides the state where the software is rewritable, for example, only to the non-permitted user first. If the software is not rewritten even after a predetermined period of time is elapsed from the guide, the processing unit 620 guides the state where the software is rewritable to all the users who can use the vehicle M including the permitted user. The processing unit 620 may guide the state where the software is rewritable to the users in order from the user of which the rewriting history is the smallest. By preferentially guiding the state where the software is rewritable to the non-permitted user, biased execution of the rewriting process by a part of the users can be prevented.

The guide of the state where the software of the vehicle M is rewritable can be executed, for example, by sending a predetermined message (for example, an E-mail) such as “The software of the vehicle is can be updated. Get a chance of increasing the discount rate by updating the software using the vehicle!” to the contact address of the user.

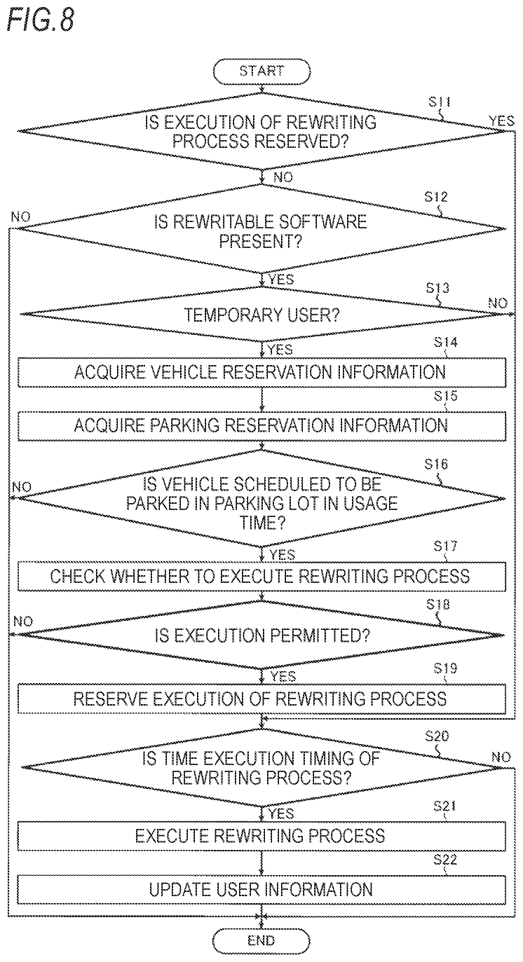

Next, an example of the process performed by the software rewriting device 60 will be described. First, a rewriting execution process for allowing the software rewriting device 60 to execute the rewriting process will be described with reference to FIG. 8. The software rewriting device 60 executes the rewriting execution process illustrated in FIG. 8 at predetermined cycles, for example, when the vehicle M is used by any user (for example, the ignition power of the vehicle M is turned on).

As illustrated in FIG. 8, in the rewriting execution process, the software rewriting device 60 determines whether the execution of the rewriting process is reserved (Step S11). The execution of the rewriting process is reserved through the process of Step S19 described below. When the software rewriting device 60 determines that the execution of the rewriting process is reserved (YES in Step S11), the software rewriting device 60 proceeds to the process of Step S20.

When the software rewriting device 60 determines that the execution of the rewriting process is reserved (NO in Step S11), the software rewriting device 60 determines whether the rewritable software of the vehicle M is present, for example, by inquiring the software distribution server 500 about the presence (Step S12). When the software rewriting device 60 determines that the rewritable software is not present (NO in Step S12), the software rewriting device 60 ends the rewriting execution process illustrated in FIG. 8.

When the software rewriting device 60 determines that the rewritable software is present (YES in Step S12), the software rewriting device 60 determines whether the current user that is currently using the vehicle M is the temporary user (Step S13). When the software rewriting device 60 determines that the current user that is currently using the vehicle M is not the temporary user (NO in Step S13), the software rewriting device 60 proceeds to Step S20.

When the software rewriting device 60 determines that the current user that is currently using the vehicle M is the temporary user (YES in Step S13), The software rewriting device 60 acquires the vehicle reservation information regarding the vehicle M from the vehicle management server 450 (Step S14), and acquires the parking reservation information regarding the vehicle M from the parking lot management device 400 (Step S15).

The software rewriting device 60 determines whether the vehicle M is scheduled to be parked in the parking lot PA by the current user in the usage period of time based on the vehicle reservation information acquired through Step S14 and the parking reservation information acquired through Step S15 (Step S16). When the software rewriting device 60 determines that the vehicle M is not scheduled to be parked in the parking lot PA (NO in Step S16), the software rewriting device 60 ends the rewriting execution process illustrated in FIG. 8.

When the software rewriting device 60 determines that the vehicle M is scheduled to be parked in the parking lot PA (YES in Step S16), the software rewriting device 60 checks with the current user whether to execute the rewriting process (Step S17). The software rewriting device 60 determines whether the execution of the rewriting process is permitted (Step S18). When the execution of the rewriting process is not permitted (NO in Step S18), the software rewriting device 60 ends the rewriting execution process illustrated in FIG. 8.

When the execution of the rewriting process is not permitted (YES in Step S18), the software rewriting device 60 reserves the execution of the rewriting process (Step S19). In Step S19, the software rewriting device 60 stores, for example, information representing that the rewriting process is executed when the vehicle M is parked in the parking lot PA in the storage unit 640 or the like.

Next, the software rewriting device 60 determines whether an execution timing of the rewriting process is reached (Step S20). For example, it is assumed that, as the information representing the reservation of the execution of the rewriting process, information representing that the rewriting process is executed when the vehicle M is parked in the parking lot PA is stored. Here, in Step S20, the software rewriting device 60 determines that the execution timing of the rewriting process is reached based on the fact that the vehicle M is parked in the parking lot PA, that is, the vehicle M is stopped at a position in the parking lot PA. When the software rewriting device 60 determines that the execution timing of the rewriting process is not reached (NO in Step S20), the software rewriting device 60 ends the rewriting execution process illustrated in FIG. 8.

When the software rewriting device 60 determines that the execution timing of the rewriting process is reached (YES in Step S20), the software rewriting device 60 executes the rewriting process (Step S21) and rewrites the software of the vehicle M. The software rewriting device 60 updates the user information corresponding to the current user (Step S22) and ends the rewriting execution process illustrated in FIG. 8.

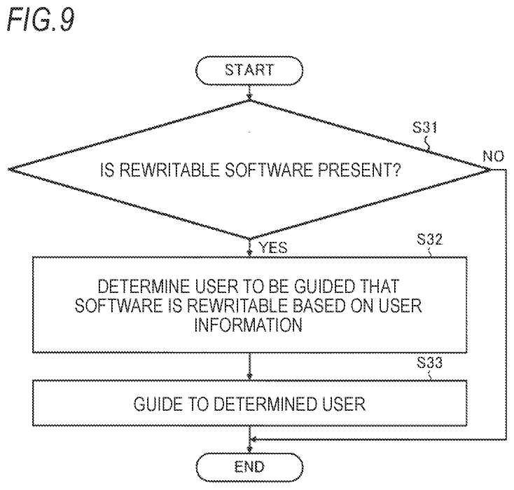

Next, a guide process that is executed by the software rewriting device 60 to guide the state where the software of the vehicle M is rewritable will be described with reference to FIG. 9. The software rewriting device 60 executes the guide process illustrated in FIG. 9 at predetermined cycles, for example, when the vehicle M is not used by any user (for example, the ignition power of the vehicle M is turned off).

As illustrated in FIG. 9, in the guide process, first, the software rewriting device 60 determines whether the rewritable software of the vehicle M is present, for example, by inquiring the software distribution server 500 about the presence (Step S31). When the software rewriting device 60 determines that the rewritable software is not present (NO in Step S31), the software rewriting device 60 ends the guide process illustrated in FIG. 9.

When the software rewriting device 60 determines that the rewritable software is present (YES in Step S31), the software rewriting device 60 determines a user to which a state where the software of the vehicle M is rewritable is guided with reference to the user information table 641 based on the user information of each user who can use the vehicle M (Step S32). The software rewriting device 60 guides the state where the software of the vehicle M is rewritable to the user determined through the process of Step S32 (Step S32), and ends the guide process illustrated in FIG. 9.

Whether to enable (that is, to permit) the execution of the rewriting process when the current user is the temporary user may be set by a manager of the vehicle M. As a result, when the vehicle M is used by the temporary user, the execution of the rewriting process against the will of the manager of the vehicle M can be prevented. The manager of the vehicle M may be, for example, an employee of the vehicle management company or an owner of the vehicle M, and specifically may be a user of which the user type is “manager user”. Here, the software rewriting device 60 determines whether the execution of the rewriting process is permitted when the current user is the temporary user, for example, in Step S13. When the execution of the rewriting process is permitted, the software rewriting device 60 may execute the processes after Step S14.

The invention is not limited to the embodiment described above and can be appropriately modified, improved, and the like.

For example, in the embodiment, the example in which the vehicle management server 450 and the parking lot management device 400 are realized by different servers has been described, but the embodiment is not limited thereto. For example, when the vehicle management company and the operating company of the visited facility are the same, the vehicle management server 450 and the parking lot management device 400 may be realized by the same server. A rent position or a return position of the vehicle M may be the parking lot PA.

Further, in the embodiment described above, an example of executing the rewriting process in the parking lot PA is described, but the invention is not limited thereto. The place where the rewriting process is executed may be a place where the vehicle M is systematically parked (stopped) and the software rewriting device 60 can acquire information indicating the scheduled parking period of time (scheduled stop period of time). The place where the rewriting process is executed is not limited to a public parking lot such as a parking lot PA, but may be a parking lot at an individual's home.

there, in the embodiment described above, an example in which a moving body is a vehicle is described, but the invention is not limited thereto. The idea of the invention can be applied not only to vehicles but also to robots, ships, aircrafts, and the likes which have a drive source and can move by the power of the drive source. Similarly, the accommodation area may be a hangar, a berth, a parking apron, or the like.

At least the following matters are described in the specification. The components and the like corresponding to those of the embodiment described above are shown in parentheses, but the invention is not limited thereto.

(1) A software rewriting device (software rewriting device 60) configured to rewrite software of a moving body (vehicle M), the device comprising:

a user information acquisition unit (user information acquisition unit 611) configured to acquire information regarding whether a user who uses the moving body is a temporary user who is capable of temporarily using the moving body;

a usage period-of-time acquisition unit (vehicle reservation information acquisition unit 612) configured to acquire information regarding a usage period of time where the user uses the moving body;

a scheduled stop period-of-time acquisition unit (parking reservation information acquisition unit 613) configured to acquire information regarding a scheduled stop period of time where the moving body is stopped at a predetermined position; and

a processing unit (processing unit 620) configured to execute a rewriting process of rewriting the software, in which

when the moving body is stopped at the predetermined position in the usage period of time based on the information regarding the usage period of time and the information regarding the scheduled stop period of time, the processing unit executes the rewriting process at the predetermined position based on permission of the temporary user.

According to (1), the rewriting process can be prevented from being executed against the will of the temporary user capable of temporarily using the moving body, and the rewriting process can be executed while avoiding deterioration in the convenience of the temporary user. Accordingly, the software of the moving body can be rewritten while avoiding deterioration in the degree of satisfaction of the temporary user for the moving body.

(2) The software rewriting device according to (1), in which

when the rewriting process is executed, a process of discounting a fee for which the temporary user uses the moving body or a fee for which the temporary user stops the moving body at the predetermined position.

According to (2), an incentive corresponding to the number of times the execution of the rewriting process is permitted can be provided, and the execution of the rewriting process is prompted.

(3) The software rewriting device according to (1) or (2), in which

when the software is rewritable, a state where the software is rewritable is guided to a permitted user who previously permits to execute the rewriting process in preference to a non-permitted user who did not previously permit to execute the rewriting process among users who are capable of using the moving body.

According to (3), an intelligent rewriting process of which execution can be easily permitted can be requested.

(4) The software rewriting device according to (3), in which

when the permitted user permits to execute the rewriting process again, a process of discounting a fee for which the permitted user uses the moving body or a fee for which the permitted user stops the moving body at the predetermined position to be cheaper than that when the permitted user previously permits to execute the rewriting process.

According to (4), as the number of times the execution of the rewriting process is permitted increases, a higher incentive can be provided, and the execution of the rewriting process is promoted.

(5) The software rewriting device according to (1) or (2), in which

when the software is rewritable, a state where the software is rewritable is guided to a non-permitted user who did not previously permit to execute the rewriting process in preference to a permitted user who previously permits to execute the rewriting process among users who are capable of using the moving body.

According to (5), biased execution of the rewriting process by a part of the users can be prevented.

(6) The software rewriting device according to any one of (1) to (5), in which

the predetermined position is an accommodation area that is capable of accommodating the moving body.

According to (6), the rewriting process can be executed in the accommodation area.

(7) The software rewriting device according to any one of (1) to (6), in which

whether to enable execution of the rewriting process when the user is the temporary user is settable by a manager of the moving body.

According to (7), when the moving body is used by the temporary user, the execution of the rewriting process against the will of the manager of the moving body can be prevented.

1. A software rewriting device, configured to rewrite software of a moving body, comprising:
a user information acquisition unit configured to acquire information regarding whether a user who uses the moving body is a temporary user who is capable of temporarily using the moving body;
a usage period-of-time acquisition unit configured to acquire information regarding a usage period of time where the user uses the moving body;
a scheduled stop period-of-time acquisition unit configured to acquire information regarding a scheduled stop period of time where the moving body is stopped at a predetermined position; and
a processing unit configured to execute a rewriting process of rewriting the software, wherein
when the moving body is stopped at the predetermined position in the usage period of time based on the information regarding the usage period of time and the information regarding the scheduled stop period of time, the processing unit executes the rewriting process at the predetermined position based on permission of the temporary user.

2. The software rewriting device according to claim 1, wherein
when the rewriting process is executed, a process of discounting a fee for which the temporary user uses the moving body or a fee for which the temporary user stops the moving body at the predetermined position.

3. The software rewriting device according to claim 1, wherein
when the software is rewritable, a state where the software is rewritable is guided to a permitted user who previously permits to execute the rewriting process in preference to a non-permitted user who did not previously permit to execute the rewriting process among users who are capable of using the moving body.

4. The software rewriting device according to claim 3, wherein
when the permitted user permits to execute the rewriting process again, a process of discounting a fee for which the permitted user uses the moving body or a fee for which the permitted user stops the moving body at the predetermined position to be cheaper than that when the permitted user previously permits to execute the rewriting process.

5. The software rewriting device according to claim 1, wherein
when the software is rewritable, a state where the software is rewritable is guided to a non-permitted user who did not previously permit to execute the rewriting process in preference to a permitted user who previously permits to execute the rewriting process among users who are capable of using the moving body.

6. The software rewriting device according to claim 1, wherein
the predetermined position is an accommodation area that is capable of accommodating the moving body.

7. The software rewriting device according to claim 1, wherein
whether to enable execution of the rewriting process when the user is the temporary user is settable by a manager of the moving body.
